(19) United States
(12) Patent Application Publication
(10) Pub. No.: US 2009/0039179 A1
(43) Pub. Date: Feb. 12, 2009

(54) MEDICINE SPRAYING DEVICE

(75) Inventors: Katsuyoshi Kado, Hyogo (JP); Yuri Nakamura, Hyogo (JP); Kosuke Hiraoka, Hyogo (JP); Kiyofumi Watanabe, Hyogo (JP); Kenji Tatami, Hyogo (JP)

Correspondence Address: MOORE & VAN ALLEN PLLC, P.O. BOX 13706, Research Triangle Park, NC, 27709, US

(73) Assignee: EARTH CHEMCIAL CO., LTD., CHYODA-KU TOKYO (JP)

(21) Appl. No.: 10/598,214

(22) PCT Filed: Oct. 4, 2004
(86) PCT No.: PCT/JP04/14607

§ 371 Date: Aug. 21, 2006

(30) Foreign Application Priority Data
Feb. 26, 2003 (JP) 2003048809
Feb. 25, 2004 (JP) 2004-049379

(51) Int. Cl. B05B 3/00

(52) U.S. Cl. 239/225.1

(57) ABSTRACT

A device is provided to be able to spray over a wide range and suppress a chilling injury. In the device, a rotating nozzle is connected to a connection pipe having a connection passage in communication to a nozzle stem of an aerosol can to have an outlet directed laterally. The rotating nozzle comprises a hollow support having a connection passage connected to a connection passage outlet of the connection pipe and a hollow arm rotatably supported at a tip end of the support, and an arm orifice is provided at a tip end of a connection passage in the arm and oriented such that reaction force of spray causes the rotating nozzle to rotate and aerosol contents are sprayed forwardly of a rotating plane of the rotating nozzle.

### TECHNICAL FIELD

The present invention relates to a device for spraying chemicals to spray aerosol contents containing a chemical or the like that prevents noxious organisms.

### BACKGROUND ART

Conventionally, aerosol bombs are given to spray contents containing a chemical or the like that prevents noxious organisms such as noxious insects, mold, etc In order to prevent, for example, noxious insects swarming on vegetation, horticultural aerosol bombs are known to spray a chemical toward noxious insects.

With such horticultural aerosol bombs, contents are sprayed on vegetation, on which noxious insects swarm, from a nozzle upon depression of a push button on a top of a can, but their ranges are short and their coverages are restricted to a narrow range, so that there is involved a problem that the contents are concentrated locally on vegetation to cause a chilling injury.

Therefore, in order to prevent a chilling injury, it is necessary to reduce a spray quantity and to repeatedly spray little by little, which causes a disadvantage to require labor.

On the other hand, there are sprayers to spray a large amount of contents over a wide range at a time. In order to prevent, for example, noxious insects living mainly on floor surfaces such as tatami mat, carpet, mat, etc., there is known a device provided with a rotating head, which includes a spray nozzle directed radially and rotates horizontally on a floor, to spray contents radially widely (see Patent Document 1).

However, with the device described in Patent Document 1, a sprayer is placed on a floor and is restricted to indoor use for radially wide spraying but no chilling injury to vegetation is taken account of and the device is not suited to application on outdoor vegetation and is different from an aerosol bomb for portable use.

Patent Document 1: JP-A-11-57537

### DISCLOSURE OF THE INVENTION

It is an object of the invention to provide a device for spraying chemicals capable of divergently spraying a large amount of aerosol contents containing chemical or the like over a wide range at a time and besides causing no chilling injury to vegetation.

In order to attain the above object, according to the invention, aerosol contents sprayed from a nozzle stem at a top of an aerosol can by pushing a push button are not sprayed as they are but once led laterally through a connection passage connected to the nozzle stem, a rotating nozzle is provided at a tip end of the passage, the nozzle is caused to rotate by a reaction force of spray from the nozzle, and arm orifices are formed in directions, in which the aerosol contents are sprayed forwardly of a rotating plane. Here, spraying forwardly of the rotating plane means spraying forwardly of a plane perpendicular to a center line of rotation of the nozzles.

Such device for spraying chemicals comprises a hollow support having a connection passage in communication to a nozzle stem at a top of an aerosol vessel and arranged laterally relative to the aerosol vessel, a rotating nozzle rotatably supported at a tip end of the support and having a connection passage in communication to the passage of the support, and means to actuate the nozzle stem.

A further embodiment of the invention comprises a connection pipe mounted at a top of an aerosol vessel and having a connection passage in communication to a nozzle stem of the aerosol vessel to have an outlet directed laterally relative to the aerosol vessel, a hollow support having a connection passage connected to the outlet of the connection pipe to extend substantially perpendicular to an axis of the aerosol vessel, at least one arm having a connection passage in communication to the passage of the support and supported on the support to be rotatable about an axis thereof, and means to actuate the nozzle stem.

Further, with the device for spraying chemicals according to invention, a pair of the arms can be provided to be symmetrical about the support, and the connection pipe and the support can be connected together through a substantially stiff pipe.

For example, a part of a tip end surface of the arm is formed to define a slope of a predetermined angle, and an arm orifice is formed perpendicular to the slope to be usable for an arm orifice of the nozzle of the device according to invention. In this case, a line of intersection of a plane, which is perpendicular to a plane including a center line of rotation of the arm and an axis of the arm and in parallel to the center line of rotation of the arm, and the slope preferably has an angle (referred below to as slope angle) of at least 15° but less than 90° relative to a plane perpendicular to the center line of rotation of the arm, and besides the slope angle is more preferably in the range of at least 70° but less than 90°.

Also, in order to achieve spray in an extensive and divergent configuration in the device according to invention, an angle formed between a center line of spray, along which aerosol contents are sprayed, and a plane perpendicular to a center line of rotation of the arm is preferably larger than 0° but not larger than 45°.

According to invention, it is possible to provide a device for spraying chemicals capable of spraying a large amount of aerosol contents over a wide range at a time and besides causing no chilling injury to vegetation.

Further, the device for spraying chemicals according to invention can be used to prevent noxious insects, such as flea, louse, etc., parasitic on human, animals, or the like, in which case a feeling of cold is less and not prolonged. Further, wetting is less when applied to a cushion and cloth products.

### BRIEF DESCRIPTION OF THE DRAWINGS

FIG. 1 is a side view showing a whole outward appearance of an embodiment of the invention.

FIG. 2 is a side view showing, in enlarged scale, a rotating nozzle shown in FIG. 1.

FIG. 3 is a front view showing a cross section of an arm portion of the rotating nozzle taken along the line II-II in FIG. 2.

FIG. 4 is a perspective view showing the rotating nozzle of FIG. 2 in a state, in which a part of a tip end surface of the arm portion defines a slope and aerosol contents are sprayed from an arm orifice formed perpendicular to the slope.

FIG. 5 is a front view showing the arm portion in a state, in which aerosol contents are sprayed from the arm orifices formed on the slopes at the tip ends of the arm portion and the rotating nozzle is rotated in a direction indicated by an arrow by its reaction.

FIG. 6 is a perspective view showing the rotating nozzle of FIG. 2, a slope angle, and an angle formed between a center line of spray and a plane perpendicular to a center line of rotation of the arms.

### BEST MODE FOR CARRYING OUT THE INVENTION

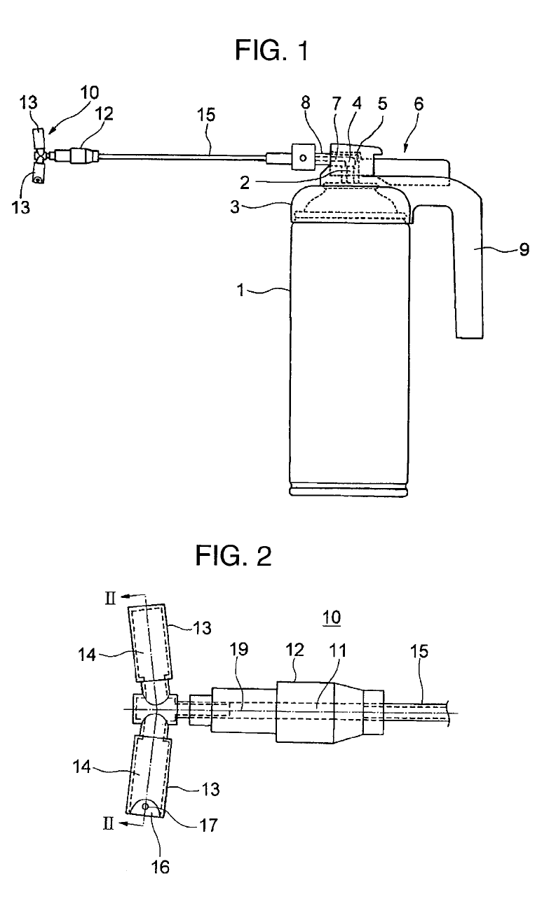

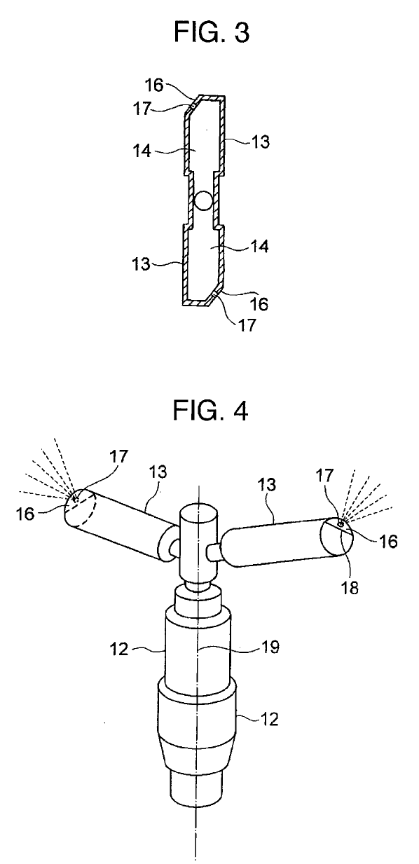

FIG. 1 is a side view showing an outward appearance of a portable type device according to a preferred embodiment of the invention, and the reference numeral 1 denotes an aerosol can charged with aerosol contents (referred below to as contents) composed of an undiluted solution, such as ethanol, etc., in which a chemical is dissolved, and a propellant such as liquefied gas, etc., and 2 denotes a nozzle stem provided at a top of the aerosol can to permit a chemical component of the contents to be sprayed with an appropriate particle size when being pushed down in an axial direction of the aerosol can. Here, the particle size indicates an average particle size obtained under the following condition, and preferably ranges from 15 to 50 μm.

The average particle size is measured by a particle size distribution measuring device to mean D50 (cumulative 50%) analyzed by an automatic computing processing unit. Concretely, a specimen is sprayed from a position, in which a distance between the laser beam irradiated on a radiation receiving portion of the particle size distribution measuring device from a laser-radiation emitting portion thereof and a spray port of a specimen amounts to about 50 cm, in such a manner that a sprayed substance passes the laser beam perpendicularly. The average particle size is obtained by making measurement during the spray and analyzing the particle size distribution of the sprayed substance with the use of the automatic computing processing unit.

A cap 3 is fitted onto an upper end of the aerosol can to surround a space, into which the nozzle stem 2 projects, and the cap mounts therein an operating lever 6 having a push button 5 including an inlet hole 4 fitted onto a tip end of the nozzle stem 2 and a rear end molded integrally with the push button to extend rearward from the cap. The operating lever 6 is supported by a pair of opposed projections, of which tip ends are integrally molded in the cap, to swing with the projections as a fulcrum.

The push button 5 is formed with a passage 7, which includes an inlet aligned with the nozzle hole of the nozzle stem 2, the passage being bent at a right angle to connect to a passage of a connection pipe 8. Consequently, the inlet hole 4 of the push button 5 and a passage outlet of the connection pipe 8 form a right angle therebetween. In the figure, the reference numeral 9 denotes a grip formed integral with the cap 3.

The reference numeral 10 denotes a rotating nozzle to constitute an essential part of the invention. As shown in enlarged scale in FIG. 2, the rotating nozzle 10 comprises a hollow support 12 having therein an axial passage 11, and a pair of cylindrical-shaped arms 13 supported at a tip end of the support to be rotatable in a vertical plane, and passages 14 are formed in communication to the passage 11 in the support and closed at tip ends thereof. As shown in FIGS. 1 and 2, the arms 13 may be mounted in a manner to incline somewhat forward relative to a direction perpendicular to the support 12. The connection pipe 8 and the support 12 are connected together by a hard pipe 15 of a suitable length, and the passage of the connection pipe 8 is communicated through a passage of the pipe 15 to the passage 11 in the support 12. The support 12, the connection pipe 8, and the pipe 15 are suitably formed from a resin, such as polyacetal, polyethylene, polypropylene etc., and a metal such as brass, stainless steel, etc.

The support 12 preferably has a length of 1 to 10 cm, an inside diameter of 1 to 5 mm, and a peripheral wall thickness of 0.5 to 2 mm.

The pipe 15 preferably has a length of 3 to 30 cm and an inside diameter of 0.8 to 3 mm.

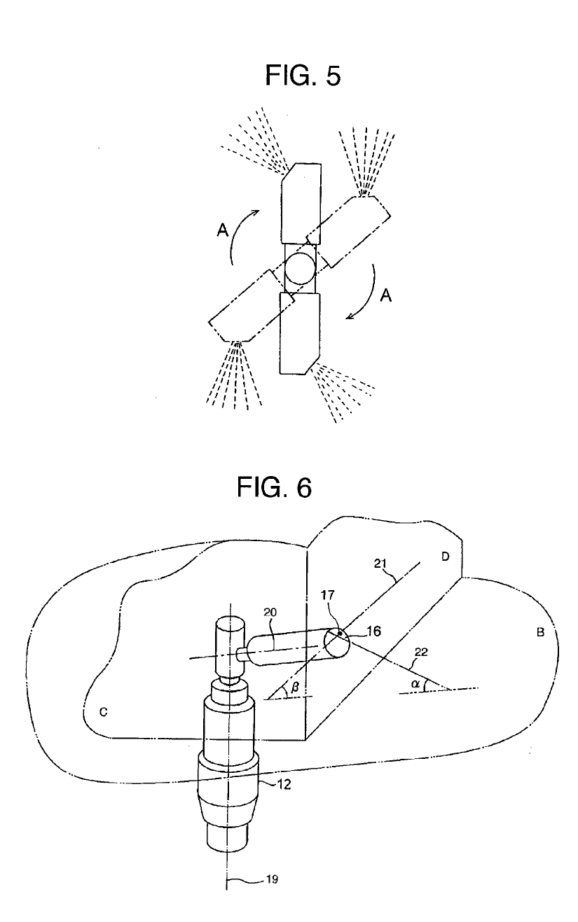

As shown in FIG. 4, the arms 13 have a substantially circular tip end surface, a part of which defines a flat slope 16, and an arm orifice 17 is formed perpendicular to the slope 16 and in communication with the passage 14 in the arm. The slope is set to have a predetermined angle relative to the axis of the arm, and a boundary line 18 between the tip end surface of the arm and the slope is set to have an angle other than a right angle relative to an axis 19 of the support 12. Thus the contents sprayed from the arm orifice 17 have a component directed forward relative to the arm in a direction of rotation and are sprayed forward and obliquely outward, so that the arm sprays the contents outward forwardly of the rotating plane of the arm while rotating in a direction indicated by an arrow A in FIG. 5. A favorable sense of use (sound of rotation) is obtained when the number of rotations of the nozzle is 10000 rpm or higher.

An angle of the slope will be described with reference to FIG. 6. Let assume a plane C including a center line 19 of rotation of the arms and an axis 20 of the arms and let assume a plane D perpendicular to the plane C and in parallel to the center line 19 of rotation of the arms. An angle α, which a line 22 of intersection of the slope and the plane D forms relative to a plane B perpendicular to the center line 19 of rotation of the arms, is a slope angle. In the embodiment shown in FIG. 4, the line 22 of intersection of the slope and the plane D corresponds to the boundary line 18. According to experimental results, the slope angle is preferable in the range of 15° or more but less than 90°, more preferable in the range of 70° or more but less than 90°, and most preferably 86°. With the slope angle of less than 15°, spray becomes linear and does not spread adequately, and with the slope angle of 90°, spray around the rotating plane of the arm is sufficient but forward spray is insufficient.

Let assume a center line 21 of spray emitted from the arm orifice 17. The center line 21 of spray passes a center of the arm orifice 17 and is in parallel to a direction, in which most of the contents is sprayed from the arm orifice 17. Like the embodiment shown in FIG. 4, in the case where the arm orifice is formed perpendicular to the slope, the center line 21 of spray defines a line passing the center of the arm orifice and being perpendicular to the slope. In order to achieve an extensive and divergent spray with the nozzle of the device of the invention, an angle β formed between the center line of spray, along which the aerosol contents are sprayed, and a plane perpendicular to the center line of rotation of the arms is preferably larger than 0° but equal to 45° or less.

In explaining the action of the invention, in an unused state, the weight of the rotating nozzle 10 mounted to the tip end of the connection pipe 8 lifts a rear end of the operating lever 6, the nozzle stem 2 projects upward, and the aerosol contents are put in a state of being sealed in the can. When the grip 9 is grasped and the rear end of the operating lever 6 is pushed down, the inlet hole 7 of the push button 5 pushes the nozzle stem 2 to allow the contents of the aerosol can to stream into the passage 7 of the push button 5. The streamed contents are fed to the rotating nozzle 10 and sprayed in front of the rotating nozzle from the arm orifice 17 at tip ends of the arms 13 as described above. According to the invention, since the contents sprayed upon the operation of the push button with the operating lever 6 are augmented in spray forces by the rotation of the arms 13 to reach a distant location in an extensive area, the contents scattered per unit area of vegetation are reduced in quantity and a distance to vegetation is long, so that the contents sprayed in a low temperature state are raised in temperature and the propellant mixed in the contents is liable to vaporize, thus enabling suppressing a chilling injury to vegetation. Also, since the contents are sprayed extensively, it is possible to efficiently exterminate noxious insects.

Since the connection pipe 8 and the support 12 of the rotating nozzle 10 are connected together through the elongated pipe 15, the device of the invention described above has the advantage of pushing the rotating nozzle 10 into bush of vegetation to be able to spray the chemical on noxious insects present therein. In the case where there is no need therefor, the invention can be embodied even when the pipe 15 is omitted and the connection pipe 8 and the rotating nozzle support 12 are connected directly to each other. Also, while the rotating nozzle making use of the pair of arms 13 has been described, the invention can apparently be embodied even with the number of arms being three or more.

In addition, the invention can use, as a chemical, one kind or two kinds or more of pyrethroid compounds such as natural pyrethrin, prallethrin, imiprothrin, phthalthrin, allethrin, transfluthrin, resmethrin, phenothrin, cyphenothrin, d,d-T99-cyphenothrin, permethrin, cypermethrin, ethofenprox, cyfluthrin, deltamethrin, bifenthrin, fenvalerate, fenpropathrin, silafluofen, (S)-2-methyl-4-oxo-3-(2-propynyl)-cyclopent-2-enyl (1R)-trans-3-(2,2-dichlorovinyl)-2-dimethylcyclopropanecarboxylate, metofluthrin, profurthrin, S-1864 (manufactured by Sumitomo Chemical Industries); organophosphorus compounds such as dichlorvos or the like; carbamate compounds such as propoxur or the like; oxadiazole compounds such as methoxadiazone or the like; sulfonamide compounds such as amidflumet or the like; nicotinoid compounds such as dinotefuran, clotianidin, nitenpyram, acetamiprid, imidacloprid, or the like; pyrazole compounds such as fipronil or the like; insecticidal refined oil such as menthol, benzyl alcohol, or the like; repellent refined oil such as orange oil, cassia oil, grapefruit oil, clove oil, cedar oil, citronella oil, cinnamon oil, cinnamon leaf oil, geranium oil, thyme white oil, mentha oil, white-cedar oil, pimento oil, fennel oil, peniroyal oil, peppermint oil, bergamot oil, lavender oil, roux oil, lemonglass oil, tea tree oil, white-cedar oil, or the like; boron compounds such as boric acid, borax, or the like; insecticide such as indoxacarb, chlorphenapyr, emamectin, thiamethoxam, pymetrozine, isopropylmethyl phenol, or the like; disinfectant (antifungal agent) such as thymol, thiophroteet-methyl, tetrachloroisophthalonitrile, triforine, imibenconazole, thiophanate-methyl, or the like; deodorizer such as polyphenol, cyclodextrin, or the like.

It is possible to use, as the propellant, one kind or two kinds or more of compressed gases such as nitrogen gas, compressed air, carbon dioxide, etc., hydrofluorocarbon, such as HFC-152a, HFC-134a, etc., liquefied gas such as dimethyl ether, etc., liquefied petroleum gas such as propane, butane, isobutane, etc., pentane such as normal pentane, isopentane, cyclopentane, etc., and the like.

Also, it is possible to use, as a solvent for the undiluted solution, one kind or two kinds or more of water, isopropanol, n-propanol, kerosene (first numbered kerosene), isopentane, 2,3-dihydrodecafluoropentane, etc. Further, various surface active agents, stabilizing agents, flavors, pigments, etc. may be used at need.

### EXPERIMENTAL EXAMPLE 1

An experiment was carried out to make a comparison of reduced temperature between a conventional aerosol bomb (comparative product) with an ordinary spray orifice, for which an ordinary push button was used, and an aerosol bomb (a product of the invention) with a device, in which the rotating nozzle (a nozzle having an slope angle of 60° was used) of the invention was used, and results are as follows.

Isopropyl alcohol (undiluted solution) and LPG (propellant) were charged into respective aerosol cans to provide for aerosol agents (the ratio of undiluted solution/gas was 30/70 vol %), the aerosol agents were sprayed from a predetermined distance away toward a thermometer for three seconds with a spray quantity of about 3 g, and temperature reduction was measured, from which results indicated in TABLE 1 were obtained.

TABLE 1
Results of Confirmation of Temperature Reduction

| | Spray Distance | | |
|---|---|---|---|
| Specimen | 10 cm | 20 cm | 30 cm |
| Comparative | −11.5° C. | −10° C. | −7.5° C. |
| Product | | | |
| Product of | −6.5° C. | −4.0° C. | −3.0° C. |
| Invention | | | |

Likewise, it was confirmed whether any chilling injury was caused when the respective aerosol agents of about 3 g were sprayed from a predetermined distance away on leaves of a chrysanthemum seedling for three seconds, from which results indicated in TABLE 2 were obtained.

TABLE 2
Results of Confirmation of Chilling Injury to
Chrysanthemum Seedling

| | Spray Distance | | |
|---|---|---|---|
| Specimen | 10 cm | 20 cm | 30 cm |
| Comparative | Wither | Wither | Wither |
| Product | | | |
| Product of | Somewhat | No chilling | No chilling |
| Invention | chilling | injury | injury |
| | injury | | |

In addition, a spray width of contents in a position distant 40 cm from the spray nozzle was 13 cm for the conventional ordinary spray orifice, and 20 cm in the use of the rotating nozzle of the invention. In this experiment, particles sprayed from the rotating nozzle had an average particle size of 25 μm. This value was small as compared with the conventional ordinary spray orifice. In addition, the average particle size was an average value of three measurements.

The experimental results apparently indicate that the rotating nozzle of the invention is remarkably improved in terms of temperature reduction of aerosol contents, which reached an object, as compared with the conventional aerosol bomb with the ordinary spray orifice, and produces the effect of suppression of a chilling injury to vegetation. Further, it is found that the spray distance was maintained and the spray width in a position distant 40 cm was enlarged. In addition, no chilling injury was suffered when the rotating nozzles having slope angles of 15° and 30° were used likewise to confirm any chilling injury.

### EXPERIMENTAL EXAMPLE 2

In order to examine influences of a slope angle on a spraying state, a spray experiment was carried out by preparing a conventional aerosol bomb with an ordinary spray orifice, for which an ordinary push button was used, and an aerosol bomb with a device, in which rotating nozzles were provided to have slope angles of 27°, 63°, 71°, 86° and 90°, respectively. Like the experiment described in Example of experiment 1, isopropyl alcohol (undiluted solution) and LPG (propellant) were charged into respective aerosol cans to provide for aerosol agents (the ratio of undiluted solution/gas was 30/70 vol %), and a spray configuration observed with a black paper in a background was examined from the side and the back. Spray with the ordinary spray orifice was given linearly forward and extended small such that its extent was in the order of several cm when spray was observed from the back. With the nozzle of the invention having a slope angle of 27°, spray assumed an extensive and divergent configuration and mist had an extent when observed from the back. With the slope angle further increased, spray was further extended and spray was increased in a circumferential direction of rotation. With the slope angles of 71° and 86°, an extent of several tens cm appeared. With the slope angle of 90°, however, spray in the circumferential direction predominated and spray was not directed forward.

Subsequently, these aerosol bomb were used and sprayed on actual vegetation. In the case where grass clustered as group planting such as planters or the like, spray was linear and so only local spray was possible with the conventional aerosol bomb while the chemical could be sprayed widely with the nozzle of the invention, especially with the nozzle of the invention having the slope angles of 71° and 86°. It was found that with the nozzle of the invention having the slope angle of 86°, the chemical could be sprayed particularly widely while with the nozzle of the invention having the slope angle of 71°, the chemical reached deep in vegetation.

Also, using a rose tree as an example of a garden tree, the nozzle was entered into the bush thereof and the chemical was sprayed thereon. While the chemical did not adhere to back sides of leaves because spray was linear with the ordinary spray orifice, the chemical went round to adhere to back sides of leaves with the nozzle of the invention having the slope angles of 71° and 86°. It was found that with the nozzle of the invention having the slope angle of 86°, the chemical could be sprayed particularly widely while with the nozzle of the invention having the slope angle of 71°, the chemical reached deep in vegetation.

### EXPERIMENTAL EXAMPLE 3

The nozzle of the invention having the slope angle of 86° was used to examine a sense of use, ease of handling, amount of adhered chemical, and the number of rotations of the nozzle according to changes in spray quantity and the ratio of undiluted solution/gas. Experimental results are indicated in TABLE 3. The spray quantity was 16 g/10 seconds for a specimen A and a specimen B while it was 10 g/10 seconds for a specimen C and specimen D. The ratio of undiluted solution/gas (vol %) was 30/70 for the specimen A and the specimen C while it was 50/50 for the specimen B and the specimen D. The sense of use was obtained by averaging results of evaluation by 17 monitor examinees, in which evaluation 5 was assumed when a feeling for sound of rotation was very good, 4 when being good, 3 when ordinary, 2 when somewhat bad, and 1 when bad. The ease of handling represents an average of results of evaluation by 17 monitor examinees, in which evaluation 1 to 5 were assumed in the same manner as described above. The amount of adhered chemical represents an average value of amounts of a chemical adhered to a paper filter having a diameter of 30 cm in three spraying actions in the case where the chemical (a chemical composed of permethrin, ethanol, and a propellant) containing 0.2% of permethrin was sprayed at an angle of 45° against the paper filter from a distance of 30 cm away for 10 seconds. The number of rotations was measured by means of a pocket revolution indicator (manufactured by Yokogawa M & C Ltd.). A reflective tape (aluminum tape sticking thereto a double tape) was stuck to one side of the arm, and the number of rotations of the nozzle was measured by having a photoelectric probe of the revolution indicator approaching the rotating arm portion while spraying the aerosol agent.

As a result, in case of the ratio of undiluted solution/gas being 50/50, a favorable evaluation was obtained with respect to the sense of use and the ease of handling when the spray quantity was both 16 g and 10 g, and a larger amount of adhered chemical was obtained than that with the case where the ratio of undiluted solution/gas was 30/70. The number of rotations of the nozzle became 20000 rpm or more when the spray quantity was 16 g (the specimen A and the specimen B).

TABLE 3
Results of Evaluation

| | Spray Amount | Ratio of | | | Amount of | Number of |
|---|---|---|---|---|---|---|
| | per | Undiluted | Sense of Use | | Adhered | Rotations |
| | 10 seconds | Solution/Gas | (Sound of | Ease of | Chemical | of Nozzle |
| Specimen | (g) | (vol %) | Rotation) | Handling | (mg) | (rpm) |
| A | 16 | 30/70 | 2.3 | 2.9 | 4.03 | 20000 |
| | | | | | | or more |
| B | 16 | 50/50 | 3.2 | 3.6 | 5.71 | 20000 |
| | | | | | | or more |
| C | 10 | 30/70 | 3.2 | 2.9 | 3.32 | 18500 |
| D | 10 | 50/50 | 3.1 | 3.2 | 4.92 | 17000 |

1. A device for spraying chemicals comprising a hollow support having a connection passage in communication to a nozzle stem at a top of an aerosol vessel and arranged laterally relative to the aerosol vessel, a rotating nozzle rotatably supported at a tip end of the support and having a connection passage in communication to the passage of the support, and means to actuate the nozzle stem, and wherein an arm orifice provided at a tip end of the passage of the rotating nozzle is formed in a direction, in which the rotating nozzle is rotated by a reaction force of spray and aerosol contents are sprayed forwardly of a rotating plane.

2. A device for spraying chemicals comprising a connection pipe mounted at a top of an aerosol vessel and having a connection passage in communication to a nozzle stem of the aerosol vessel to have an outlet directed laterally relative to the aerosol vessel, a hollow support having a connection passage connected to the outlet of the connection pipe to extend substantially perpendicular to an axis of the aerosol vessel, at least one arm having a connection passage in communication to the passage of the support and supported on the support to be rotatable about an axis thereof, and means to actuate the nozzle stem, and wherein an arm orifice is formed at a tip end of the passage of the arm in a direction, in which the arm is rotated by a reaction force of spray and aerosol contents are sprayed forwardly of a rotating plane.

3. The device according to claim 2, wherein a pair of the arms are provided to be symmetrical about the support.

4. The device according to claim 3, wherein the connection pipe and the support are connected together through a substantially stiff pipe.

5. The device according to claim 2, wherein a part of a tip end surface of the arm or arms is formed to define a slope of a predetermined angle, and the arm orifice is formed perpendicular to the slope.

6. The device according to claim 5, wherein a line of intersection of a plane, which is perpendicular to a plane including a center line of rotation of the arm and an axis of the arm and in parallel to the center line of rotation of the arm, and the slope has an angle of at least 15° but less than 90° relative to a plane perpendicular to the center line of rotation of the arm.

7. The device according to claim 6, wherein a line of intersection of a plane, which is perpendicular to a plane including a center line of rotation of the arm and an axis of the arm and in parallel to the center line of rotation of the arm, and the slope has an angle of at least 70° but less than 90° relative to a plane perpendicular to the center line of rotation of the arm.

8. The device according to claim 2, wherein an angle formed between a center line of spray, along which aerosol contents are sprayed, and a plane perpendicular to a center line of rotation of the arm is larger than 0° but not larger than 45°.

9. The device according to claim 1, wherein an angle formed between a center line of spray, along which aerosol contents are sprayed, and a plane perpendicular to a center line of rotation of the arm is larger than 0° but not larger than 45°.

10. The device according to claim 3, wherein a part of a tip end surface of the arm or arms is formed to define a slope of a predetermined angle, and the arm orifice is formed perpendicular to the slope.

11. The device according to claim 10, wherein a line of intersection of a plane, which is perpendicular to a plane including a center line of rotation of the arm and an axis of the arm and in parallel to the center line of rotation of the arm, and the slope has an angle of at least 15° but less than 90° relative to a plane perpendicular to the center line of rotation of the arm.

12. The device according to claim 11, wherein a line of intersection of a plane, which is perpendicular to a plane including a center line of rotation of the arm and an axis of the arm and in parallel to the center line of rotation of the arm, and the slope has an angle of at least 70° but less than 90° relative to a plane perpendicular to the center line of rotation of the arm.

13. The device according to claim 12, wherein an angle formed between a center line of spray, along which aerosol contents are sprayed, and a plane perpendicular to a center line of rotation of the arm is larger than 0° but not larger than 45°.

14. The device according to claim 4, wherein a part of a tip end surface of the arm or arms is formed to define a slope of a predetermined angle, and the arm orifice is formed perpendicular to the slope.

15. The device according to claim 14, wherein a line of intersection of a plane, which is perpendicular to a plane including a center line of rotation of the arm and an axis of the arm and in parallel to the center line of rotation of the arm, and the slope has an angle of at least 15° but less than 90° relative to a plane perpendicular to the center line of rotation of the arm.

16. The device according to claim 15, wherein a line of intersection of a plane, which is perpendicular to a plane including a center line of rotation of the arm and an axis of the arm and in parallel to the center line of rotation of the arm, and the slope has an angle of at least 70° but less than 90° relative to a plane perpendicular to the center line of rotation of the arm.

17. The device according to claim 16, wherein an angle formed between a center line of spray, along which aerosol contents are sprayed, and a plane perpendicular to a center line of rotation of the arm is larger than 0° but not larger than 45°.
